(19) United States
(12) Patent Application Publication
(10) Pub. No.: US 2026/0371004 A1
(43) Pub. Date: Nov. 19, 2026

(54) Sound Producing Package Having Corner-Firing and Smart Glasses Using the Same

(71) Applicant: xMEMS Labs, Inc., Santa Clara, CA (US)

(72) Inventors: Kuan-Ju Tseng, Hsinchu City (TW); Eldwin Jiaqiang Ng, Sunnyvale, CA (US); Kai-Chieh Chang, Hsinchu City (TW); Wen-Chien Chen, New Taipei City (TW); Chiung C. LO, San Jose, CA (US)

(73) Assignee: xMEMS Labs, Inc., Santa Clara, CA (US)

(21) Appl. No.: 19/672,792

(22) Filed: May 11, 2026

Related U.S. Application Data
(60) Provisional application No. 63/804,681, filed on May 13, 2025.
(60) Provisional application No. 63/880,353, filed on Sep. 12, 2025.

(51) Int. Cl. H04R 1/34; G02C 5/14; G02C 11/00; H04R 1/02; H04R 7/06

(52) U.S. Cl. CPC H04R 1/345; G02C 5/14; G02C 11/10; H04R 1/028; H04R 7/06; H04R 2499/11; H04R 2499/15

(57) ABSTRACT

The present application discloses a sound producing package. The sound producing package comprises a film structure and a covering structure; wherein a sound-port structure is formed within a corner region corresponding to an intersection of a first edge and a second edge of the covering structure; wherein the sound-port structure occupies both the first edge and the second edge in the corner region.

### CROSS REFERENCE TO RELATED APPLICATIONS

This application claims the benefit of U.S. Provisional Application No. 63/804,681, filed on May 13th, 2025. Further, this application claims the benefit of U.S. Provisional Application No. 63/880,353, filed on Sep. 12th, 2025. The contents of these applications are incorporated herein by reference.

### BACKGROUND OF THE INVENTION

### 1. Field of the Invention

The present application relates to a sound producing package and a smart glasses, and more particularly, to a sound producing package and a smart glasses with corner firing.

### 2. Description of the Prior Art

Unless otherwise indicated herein, the approaches described in this section are not prior art to the claims in this application and are not admitted as prior art by inclusion in this section.

With the rapid development of wearable technology, devices such as smart glasses, and headsets have become increasingly popular. These head-mounted devices not only provide visual information but also require integrated audio systems to deliver an immersive user experience.

However, integrating sound producing devices into such wearable devices presents significant engineering challenges, primarily due to severe space constraints. For instance, in smart glasses, the electronic components and the sound producing package must be accommodated within the temple. To maintain a sleek, lightweight, and aesthetically pleasing design, the internal volume available within the temple structure is extremely limited.

Conventional sound producing packages, such as traditional dynamic speakers or standard MEMS speakers, typically utilize a planar sound emission approach where the sound port is disposed on a single, flat surface (e.g., exclusively on a top surface or solely along one longitudinal side of the package). When such conventional packages are mounted within the narrow confines of a smart glasses temple, the sound emission path is often obstructed or inefficiently routed. Consequently, the acoustic energy cannot be effectively directed toward the user's ear.

Furthermore, attempting to enlarge the sound port on a single edge of a conventional package to improve acoustic output inevitably compromises the structural integrity of the package or exceeds the physical dimensional limits of the wearable device's housing.

Therefore, how to provide a sound producing package that can be seamlessly integrated into space-constrained environments (such as the temple of smart glasses) while effectively directing acoustic energy to optimize the user’s auditory experience remains a significant objective in the field.

### SUMMARY OF THE INVENTION

It is therefore a primary objective of the present application to provide a sound producing package and a smart glasses with corner firing, to improve over disadvantages of the prior art.

An embodiment of the present application discloses a sound producing package. The sound producing package comprises a film structure and a covering structure; wherein a sound-port structure is formed within a corner region corresponding to an intersection of a first edge and a second edge of the covering structure; wherein the sound-port structure occupies both the first edge and the second edge in the corner region.

An embodiment of the present application discloses a smart glasses. The smart glasses comprises a temple structure; and a sound producing package, disposed within the temple structure, comprising a film structure and a covering structure; wherein a sound-port structure is formed at a corner region corresponding to an intersection of a first edge and a second edge of the covering structure; wherein the sound-port structure occupies both the first edge and the second edge at the corner region.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a sound producing package according to an embodiment of the present application.

FIG. 2 is a schematic diagram of a sound producing package according to an embodiment of the present application.

FIG. 3 is a schematic diagram of a film structure according to an embodiment of the present application.

FIG. 4 is a schematic diagram of a top view of a sound producing package according to an embodiment of the present application.

FIG. 5 is a schematic diagram of a bottom view of a sound producing package according to an embodiment of the present application.

FIG. 6 is a schematic diagram of a sound producing package according to an embodiment of the present application.

FIG. 7 is a schematic diagram of a sound producing package according to an embodiment of the present application.

FIG. 8 is a schematic diagram of a sound producing package according to an embodiment of the present application.

FIG. 9 is a schematic diagram of a smart glasses according to an embodiment of the present application.

FIG. 10 is a schematic diagram of a temple structure of a smart glasses according to an embodiment of the present application.

### DETAILED DESCRIPTION

The technical features described in the embodiments of the present application may be mixed or combined in various ways as long as there are no conflicts between them.

In the present application, the term “coupled to” may refer to direct or indirect connection. “Component A being coupled to component B” may indicate that component A is directly connected to component B, or component A is connected to component B via some component C.

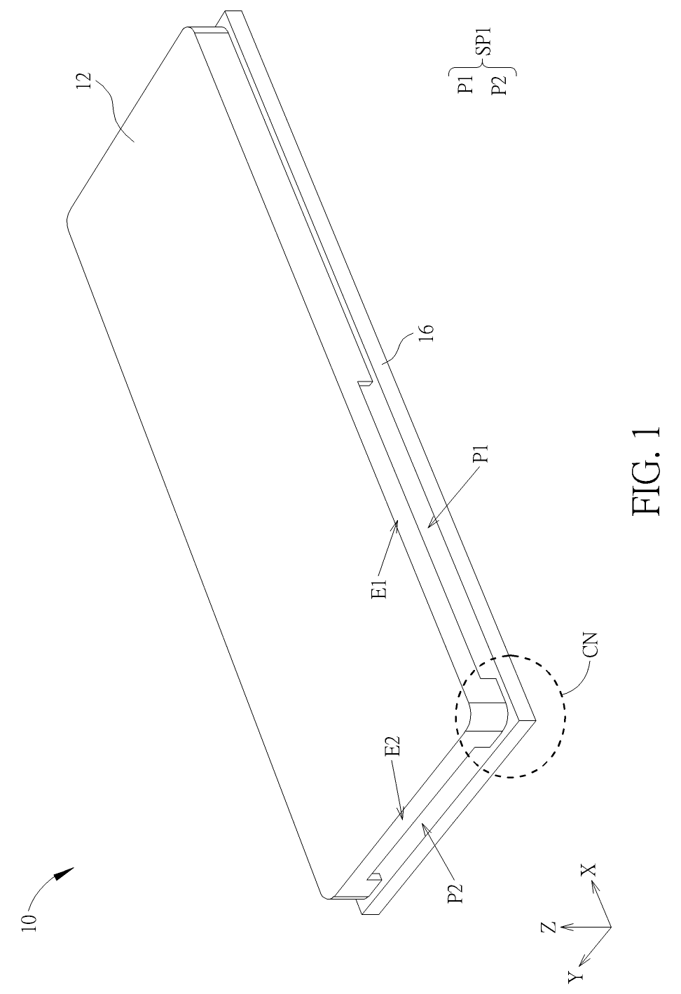

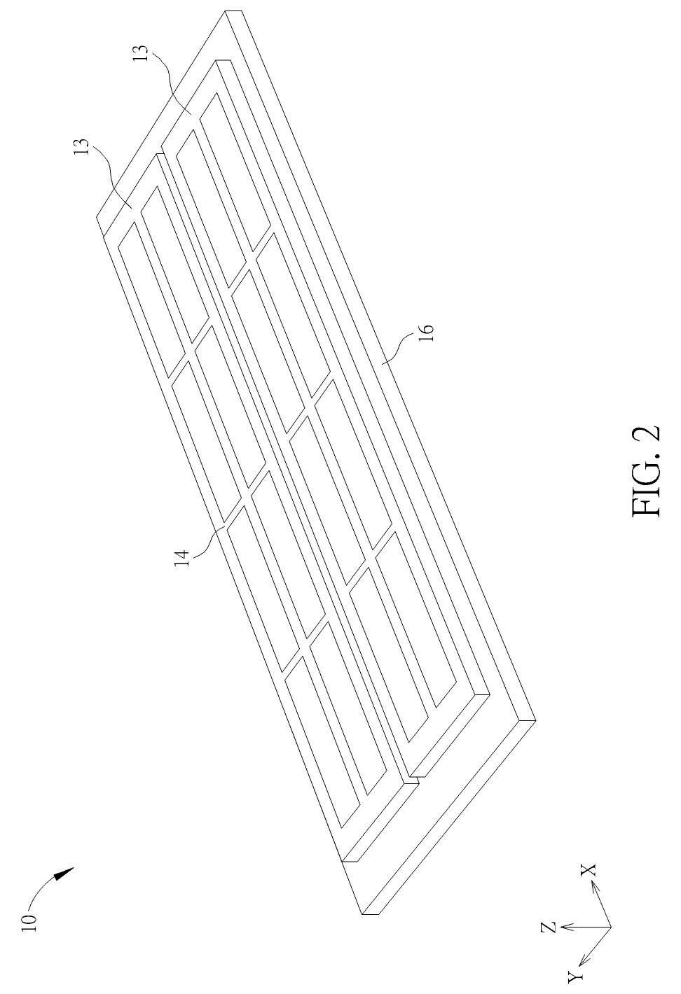

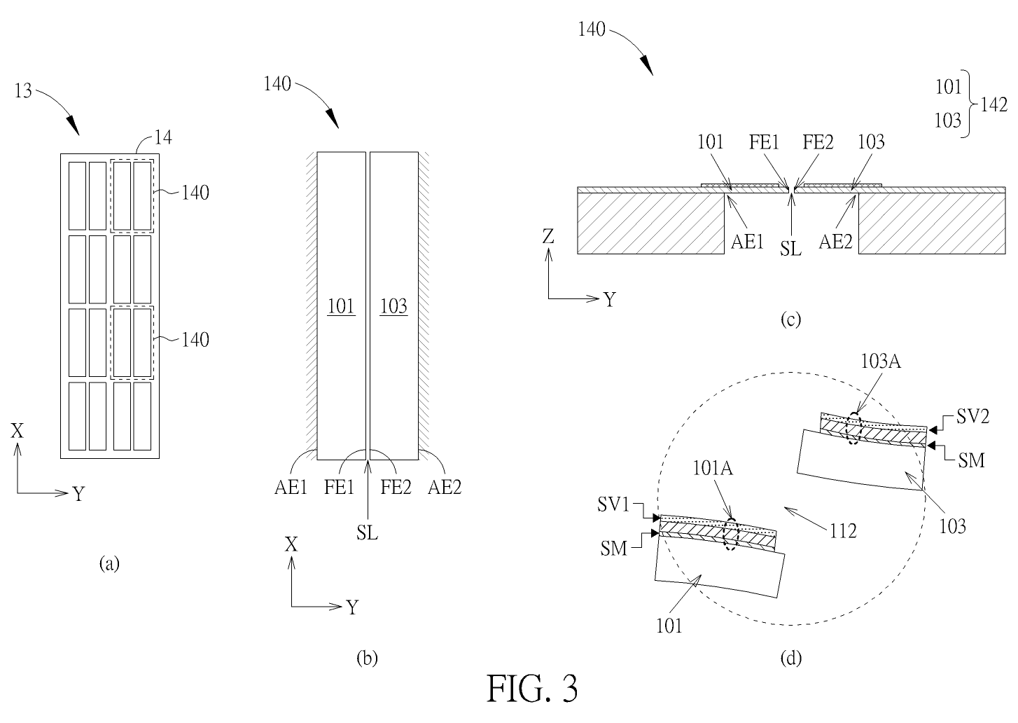

FIG. 1 is a schematic diagram of an appearance of a sound producing package 10 according to an embodiment of the present application. FIG. 2 is a schematic diagram of the sound producing package 10 without covering structure. FIG. 3 is a schematic diagram of a film structure 14 disposed within the sound producing package 10.

The sound producing package 10 comprises a covering structure 12, the film structure 14 and a substrate 16. A first port P1 is formed along a first (longitudinal/long) edge E1, and a second port P2 is formed along a second (lateral/short) edge E2. The first port P1 and the second port P2 are adjacent to a corner CN which the first edge E1 and the second edge E2 intersect. The first port P1 and the second port P2 forms a sound-port structure SP1, which means the sound-port structure SP1 comprises the first port P1 formed on the first edge E1 and the second port P2 formed on the second edge E2.

As FIG. 2 shows, the sound producing package 10 may comprise air pulse generating (APG) devices 13. Each of the APG devices 13 is configured to produce sound by generating a plurality of air pulses at an ultrasonic pulse rate. Each of the APG devices 13 comprises the film structure 14. As shown in FIG. 3(a), the film structure 14 comprises a plurality of sound producing cells 140 arranged in an array. Each sound producing cell 140 comprises a flap pair 142. The flap pair 142 comprises a first flap 101 and a second flap 103 opposite to each other. As shown in FIGS. 3(b) and 3(c) , the first/second flap 101/103 comprises a first/second anchored edge AE1/AE2 and a first/second free edge FE1/FE2. The first free edge FE1 and the second free edge FE2 are separated or defined by a slit SL formed between the first flap 101 and the second flap 103.

As shown in FIG. 3(d), the APG device 13 comprises a first actuator 101A disposed on the first flap 101 and a second actuator 103A disposed on the second flap 103. The first actuator 101A and the second actuator 103A receive valve driving signals SV1 and SV2, respectively, such that the flap pair 142 performs a differential-move movement to form a virtual valve 112. Meanwhile, the first actuator 101A and the second actuator 103A receive a pressure driving signal SM to perform a common-mode movement to form an air pressure variation.

Details of the APG device may be referred to US Patent No. 11,943,585 and Application No. 19/424,094. Content of which is incorporated herein by reference.

The arrangement of the sound ports (e.g., P1 and P2) adjacent to the corner CN is configured to concentrate/direct acoustic energy from an interior of the sound producing package 10 primarily through the corner CN, which is suitable for specific applications such as disposing in wearable device, e.g., smart glasses. Note that, in addition to smart glasses, the wearable device in the present application may be further referred to earphone, headphone, AR/VR/MR (Augmented/Virtual/Mixed Reality) device or any head mounted device.

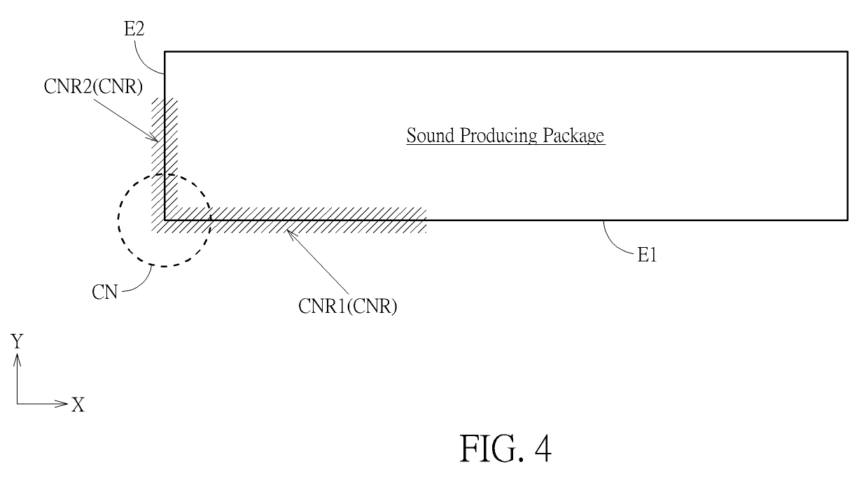

More specifically, FIG. 4 is a schematic diagram of a top view of a sound producing package (e.g.,10) of the present application. For the sound producing package of the present application, a sound-port structure is disposed/formed within a corner region CNR corresponding to a corner CN, where the corner CN is an intersection of the first edge E1 and the second edge E2 of the covering structure 10, and the corner region CNR stands for a region which originates from the corner CN and extends along both the first edge E1 and the second edge E2. In the embodiment shown in FIG. 4, the corner region CNR is/forms an L-shape region. In FIG. 4, the corner region CNR is illustrated as parallel to XY plane, which is for illustrative purposes. In fact, the corner region CNR may comprise a first portion CNR1 parallel to XZ plane attaching along the first edge E1 and a second portion parallel to YZ plane attaching along the second edge E2.

In the embodiment shown in FIG. 1, the first port P1 is within the first portion CNR1 of the corner region CNR and the second port P2 is within the second portion CNR2 of the corner region CNR. In other words, the sound-port structure SP1 occupies both the first edge E1 and the second edge E2 in the corner region CNR.

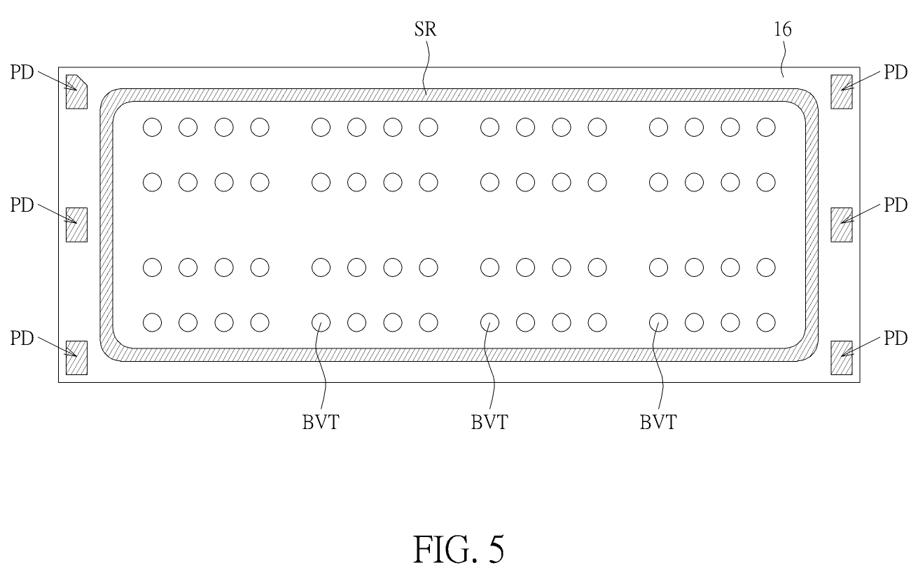

FIG. 5 is a schematic diagram of a bottom view of the sound producing package of the present application. In FIG. 5, the substrate 16 is shown. The substrate 16 may be, for example, an LGA (Land Grid Array) substrate. Back vents BVT are formed in the substrate 16. A seal ring SR is formed on a side of the substrate 16 and surrounds the back vents BVT, to prevent acoustic leakage. Lands or metal pads PD may be formed on the substrate 16 for electric signal transmission.

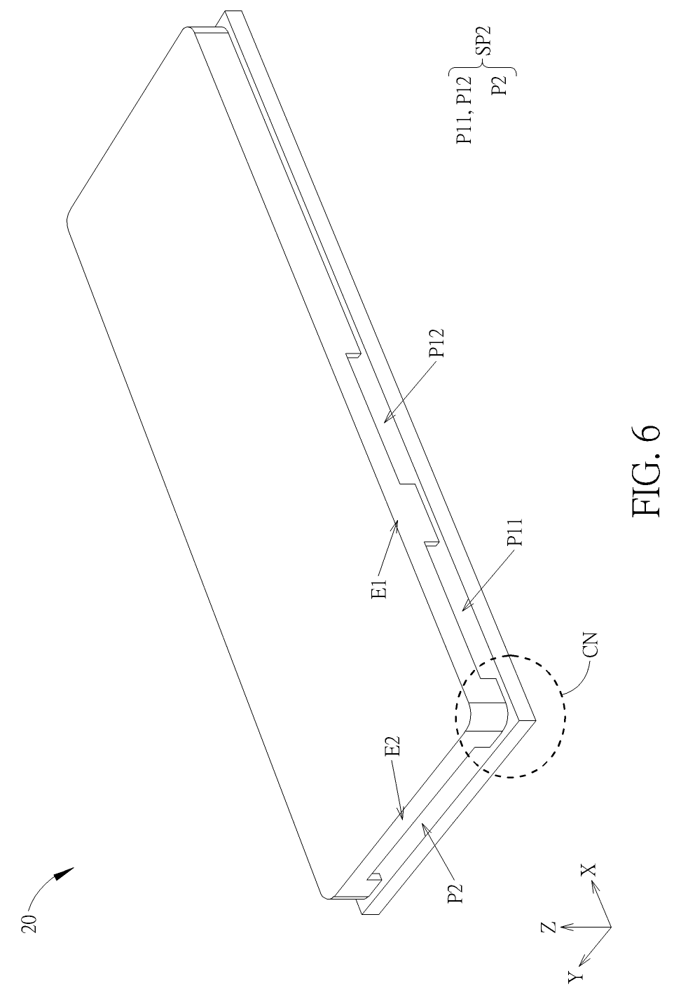

FIG. 6 is a schematic diagram of a sound producing package 20 according to an embodiment of the present application. The sound producing package 20 is similar to the sound producing package 10. Different from the sound producing package 10, the sound producing package 20 comprises ports P11 and P12 formed along the first edge E1. The ports P11, P12 and P2 form a sound-port structure SP2, which lies in the corner region CNR shown in FIG. 4.

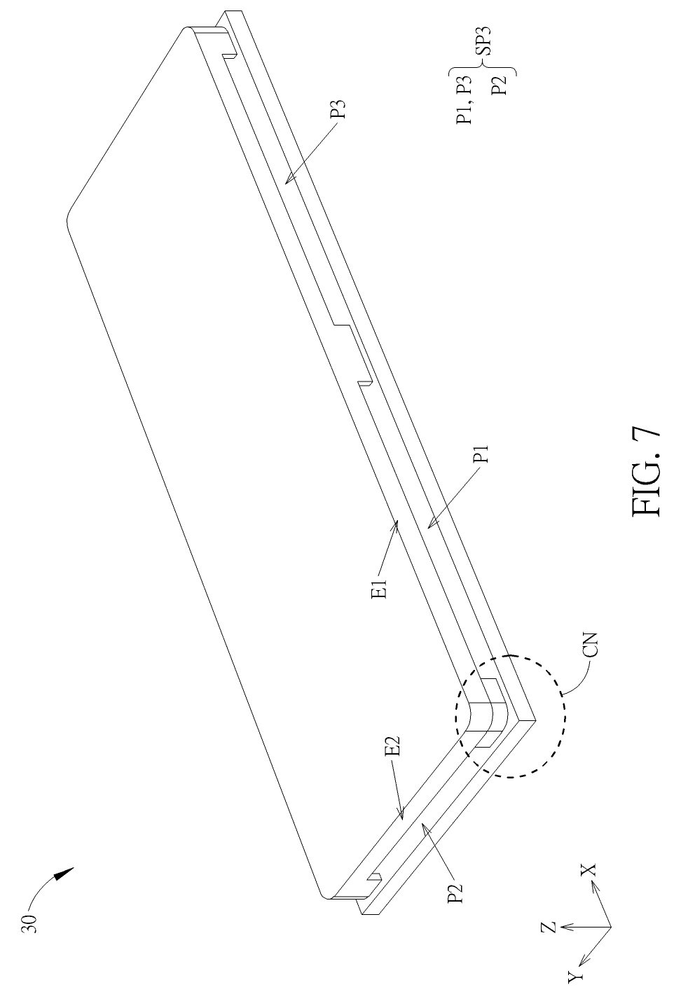

FIG. 7 is a schematic diagram of a sound producing package 30 according to an embodiment of the present application. The sound producing package 30 is similar to the sound producing package 10. Different from the sound producing package 10, the sound producing package 30 further comprises a port P3 formed along the first edge E1. The ports P1, P2 and P3 form a sound-port structure SP3, which lies in the corner region CNR shown in FIG. 4.

Note that, in the above embodiment, the first port along with the first edge E1 and the second port along with the second edge E2 are non-contiguous or separated, which is not limited thereto. The sound producing package of the present application may comprise a contiguous or merged port extending along both the first edge E1 and the second edge E2.

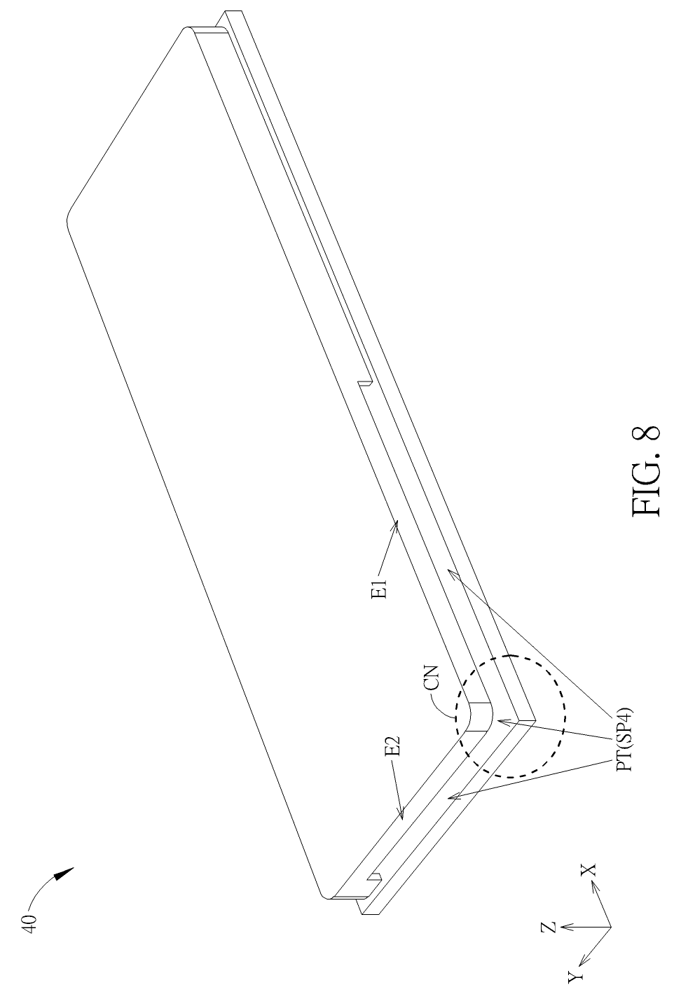

FIG. 8 is a schematic diagram of a sound producing package 40 according to an embodiment of the present application. The sound producing package 40 comprises a port PT extending along both the first edge E1 and the second edge E2. The port PT itself may be regarded as a sound-port structure SP4, which lies in the corner region CNR shown in FIG. 4.

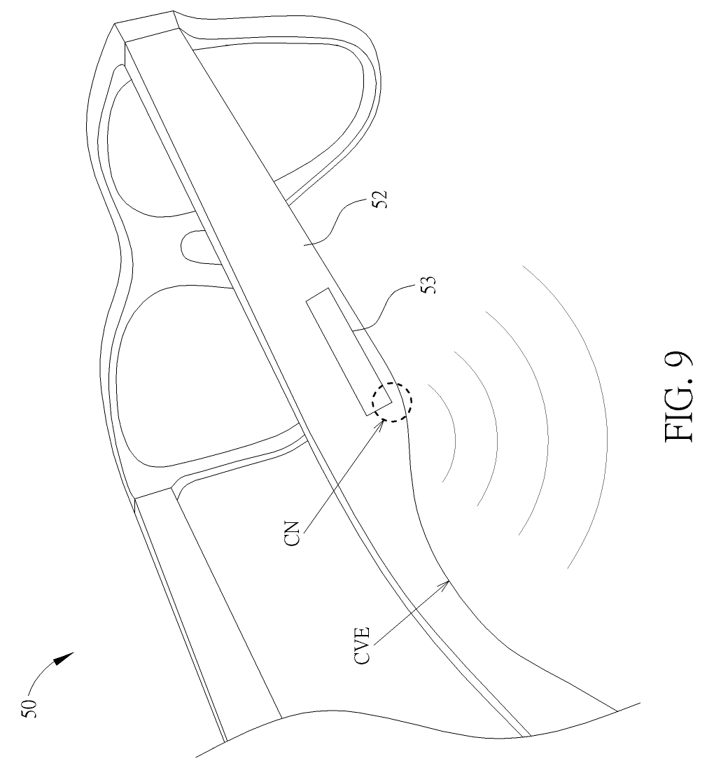

FIG. 9 is a schematic diagram of a smart glasses 50 according to an embodiment of the present application. The smart glasses 50, a wearable device, comprises a temple structure 52 and a sound producing package 53. The sound producing package 53 is disposed within the temple structure 52. The sound producing package 53 may be any sound producing package of the present application which has corner firing or has sound-port structure formed around the corner CN. To enhance user auditory experience, the sound producing package 53 may be disposed such that acoustic wave ACW propagates toward user’s ear. In an embodiment, the sound producing package 53 may be disposed such that the corner CN is proximate or adjacent to a curved edge CVE of the temple structure 52.

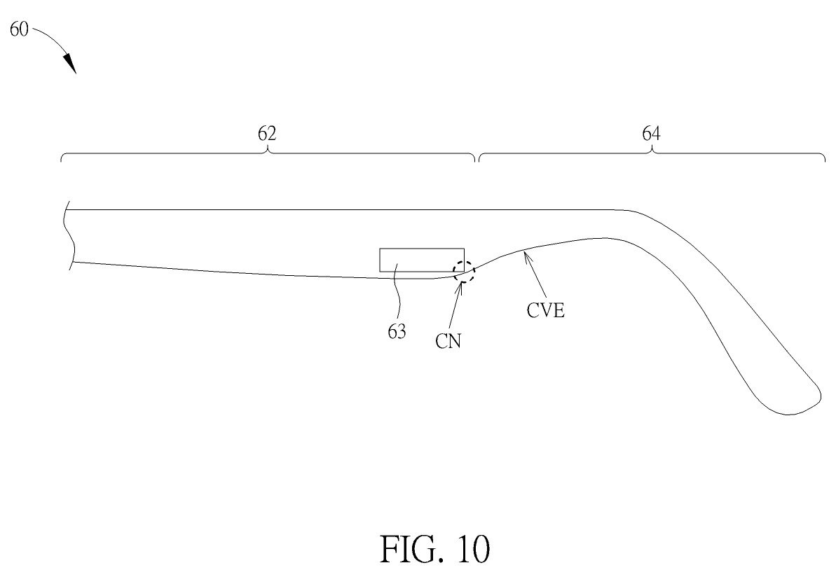

Specifically, FIG. 10 is a schematic diagram of a temple structure 60 of a smart glasses according to an embodiment of the present application. The temple structure 60 comprises a stem portion 62 and a tip portion 64. In the present application, the stem portion 62 is the longitudinal component of the temple structure 60 extending from a hinge of the glasses toward the tip portion 64, and the tip portion 64 is the curved part of the temple structure 60 (with the curved edge CVE) configured to rest or hook behind a user's ear. A sound producing package 63 would be disposed within the stem portion 62 and adjacent to the tip portion 64, such that the corner CN is proximate to the curved edge CVE.

In summary, the sound-port structure of the present application is disposed at the corner region defined by the intersection of the first edge and the second edge of the covering structure, and the sound-port structure comprises at least one sound port or opening extending along the first edge and the second edge at the corner region.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A sound producing package, comprising:
a film structure and a covering structure;
wherein a sound-port structure is formed within a corner region corresponding to an intersection of a first edge and a second edge of the covering structure;
wherein the sound-port structure occupies both the first edge and the second edge in the corner region.

2. The sound producing package of claim 1,
wherein the sound-port structure comprises a first port formed along the first edge and a second port formed along the second edge.

3. The sound producing package of claim 2,
wherein the first port and the second port are separated from each other.

4. The sound producing package of claim 1,
wherein the film structure comprises a sound producing cell;
wherein the sound producing cell comprises a flap pair;
wherein the flap pair comprises a first flap and a second flap opposite to each other.

5. The sound producing package of claim 4,
wherein the first flap comprises a first anchored edge and a first free edge;
wherein the second flap comprises a second anchored edge and a second free edge;
wherein the first free edge and the second free edge are separated by a slit formed between the first flap and the second flap.

6. The sound producing package of claim 4,
wherein the flap pair performs a differential-move movement to form a virtual valve and performs a common-mode movement to form a pressure variation.

7. The sound producing package of claim 1,
wherein the film structure comprises a plurality of sound producing cells.

8. The sound producing package of claim 1,
wherein the sound producing package is disposed within a smart glasses.

9. The sound producing package of claim 8,
wherein the smart glasses comprises a temple structure;
wherein the temple structure comprises a stem portion and a tip portion;
wherein the sound producing package is disposed within the stem portion adjacent to the tip portion.

10. The sound producing package of claim 1, comprising a substrate;
wherein the film structure and the covering structure are disposed on the substrate;
wherein a vent is formed in the substrate.

11. The sound producing package of claim 10, comprising a seal ring formed on a side of the substrate surrounding the vent.

12. A wearable device, comprising the sound producing package of claim 1.

13. A smart glasses, comprising:
a temple structure; and
a sound producing package, disposed within the temple structure, comprising a film structure and a covering structure;
wherein a sound-port structure is formed at a corner region corresponding to an intersection of a first edge and a second edge of the covering structure;
wherein the sound-port structure occupies both the first edge and the second edge at the corner region.

14. The smart glasses of claim 13,
wherein the sound-port structure comprises a first port formed along the first edge and a second port formed along the second edge;
wherein the first port and the second port are separated from each other.

15. The smart glasses of claim 13,
wherein the film structure comprises a sound producing cell;
wherein the sound producing cell comprises a flap pair;
wherein the flap pair comprises a first flap and a second flap opposite to each other.

16. The smart glasses of claim 15,
wherein the first flap comprises a first anchored edge and a first free edge;
wherein the second flap comprises a second anchored edge and a second free edge;
wherein the first free edge and the second free edge are separated by a slit formed between the first flap and the second flap.

17. The smart glasses of claim 15,
wherein the flap pair performs a differential-move movement to form a virtual valve and performs a common-mode movement to form a pressure variation.

18. The smart glasses of claim 13,
wherein the film structure comprises a plurality of sound producing cells.

19. The smart glasses of claim 13,
wherein the temple structure comprises a stem portion and a tip portion;
wherein the sound producing package is disposed within the stem portion adjacent to the tip portion.
